(19) United States
(12) Patent Application Publication
(10) Pub. No.: US 2020/0071489 A1
(43) Pub. Date: Mar. 5, 2020

(54) THERMALLY-CONDUCTIVE MATERIAL, PRODUCTION METHOD THEREFOR, AND THERMALLY-CONDUCTIVE COMPOSITION

(71) Applicant: TOYOTA JIDOSHA KABUSHIKI KAISHA, Toyota-shi (JP)

(72) Inventor: Hiroki AWANO, Susono-shi (JP)

(21) Appl. No.: 16/502,083

(22) Filed: Jul. 3, 2019

(30) Foreign Application Priority Data
Sep. 3, 2018 (JP) 2018-164659

(51) Int. Cl. C08K 9/06; C08K 3/04; C08K 3/14; C08K 3/34; C08K 3/28; C08K 5/5415

(52) U.S. Cl. CPC C08K 9/06; C08K 3/041; C08K 3/14; C08K 3/046; C08K 2003/385; C08K 3/34; C08K 3/28; C08K 5/5415; C08K 3/042

(57) ABSTRACT

The present invention provide a thermally-conductive material having improved characteristics and a method for the production thereof.

The thermally-conductive material includes a first inorganic filler, a second inorganic filler, and a coupling agent portion, wherein the first inorganic filler and the second inorganic filler are bonded to each other at one or a plurality of bonding sites, and are bonded by a single coupling agent portion at one of the bonding sites, and a method for the production of the thermally-conductive material includes the steps of supplying an inorganic filler having a hydroxy group, and mixing the inorganic filler with a coupling agent having at least two groups capable of coupling with a hydroxy group to bond the inorganic filler and the coupling agent by dehydration condensation.

### TECHNICAL FIELD

The present invention relates to a thermally-conductive material, a method for the production thereof, and a thermally-conductive composition.

### BACKGROUND ART

In recent years, in semiconductor devices for power control of hybrid vehicles and electric vehicles as well as the CPUs of high-speed computers, the ability to effectively release heat generated by the semiconductor chips to the outside, to prevent the temperatures of semiconductors therein from becoming too high, has become important.

An example of a method for solving such heat dissipation problems includes a method in which a thermally-conductive material is brought into contact with a heat generation site, whereby heat is conducted to the outside and dissipated. As such a thermally-conductive material, various materials including inorganic materials such as metals and metal oxides, and composite materials of an inorganic material and a resin have been proposed in the past.

For example, WO 2016/031888 discloses a composition for thermally-conductive materials in which a first inorganic filler and a second inorganic filler are bonded via a plurality of coupling agents. JP2003-137627A discloses a high thermal-conductivity inorganic powder in which the surface of an aluminum oxide powder or silica powder is treated with a surface treatment agent such as a silane coupling agent. JP 2010-116543A discloses a prepreg comprising an inorganic filler, which has been surface-treated with a compound comprising Si, Ti, etc., and which is dispersed in a resin body.

### SUMMARY OF THE INVENTION

### Problem to be Solved by the Disclosure

However, in conventional thermally-conductive materials, the thermal conductivity is not always sufficient, and there is room for improvement regarding an increase in thermal conductivity.

The present invention has been achieved in light of circumstances described above, and aims to provide a thermally-conductive material having improved thermal conductivity, and a method for the production thereof.

### Features for Solving the Problem

The present invention can achieve the above object by the following means.

<1> A thermally-conductive material, comprising a first inorganic filler, a second inorganic filler, and a coupling agent portion, wherein the first inorganic filler and the second inorganic filler are bonded to each other at one or a plurality of bonding sites, and are bonded by a single coupling agent portion at one of the bonding sites.

<2> The thermally-conductive material according to <1>, wherein the coupling agent portion is a portion derived from a silane compound having at least two alkoxy groups.

<3> The thermally-conductive material according to <2>, wherein the silane compound having at least two alkoxy groups is tetraethoxysilane.

<4> The thermally-conductive material according to <1>, wherein the first inorganic filler and the second inorganic filler are each independently selected from the group consisting of boron nitride, boron carbide, boron nitride carbon, graphite, carbon fiber, and carbon nanotubes.

<5> A method for the production of a thermally-conductive material, comprising the steps of:

supplying an inorganic filler having a hydroxy group, and

mixing the inorganic filler with a coupling agent having at least two groups capable of coupling with a hydroxy group to bond the inorganic filler and the coupling agent by dehydration condensation.

<6> The method for the production of a thermally-conductive material according to <5>, wherein the coupling agent is a silane compound having at least two alkoxy groups.

<7> The method for the production of a thermally-conductive material according to <6>, wherein the silane compound having at least two alkoxy groups is tetraethoxysilane.

<8> The method for the production of a thermally-conductive material according to <5>, wherein the first inorganic filler and the second inorganic filler are each independently selected from the group consisting of boron nitride, boron carbide, boron nitride carbon, graphite, carbon fiber, and carbon nanotubes.

<9> A thermally-conductive composition comprising the thermally-conductive material according to any one of <1> to <4>.

### Effects of the Invention

According to the thermally-conductive material of the present invention, by bonding the inorganic fillers with a single coupling agent portion, the thermal resistance between the inorganic fillers can be reduced, whereby thermal conductivity can be improved. Furthermore, according to the method for the production of a thermally-conductive material according to the present invention, by using an inorganic filler having a hydroxy group, affinity with the coupling agent is high, and the ratio of bonding of inorganic fillers with a single coupling agent portion is high.

### BRIEF DESCRIPTION OF DRAWINGS

FIG. 1 is a schematic view of the thermally-conductive material according to the present invention.

FIG. 2 is view showing the hydrogen bond between inorganic fillers and a coupling agent.

FIG. 3 is a view showing the bond between the inorganic fillers and the coupling agent portion.

FIG. 4 is a view showing the bond between the inorganic fillers and the coupling agent portion.

FIG. 5 is a view showing the bond between the inorganic fillers and the coupling agent portion.

FIG. 6 is a view showing the FT-IR spectrum of a boron nitride particle.

FIG. 7 is a graph showing measurement results of the thermal conductivities of materials produced in the Examples and the Comparative Examples.

### MODE FOR CARRYING OUT THE INVENTION

The embodiments of the present invention will be described in detail below. Note that the present invention is not limited to the embodiments below, and various modifications can be made within the scope of the gist of the present invention.

«Thermally-Conductive Material»

The thermally-conductive material of the present invention comprises a first inorganic filler, a second inorganic filler, and a coupling agent portion, wherein the first inorganic filler and the second inorganic filler are bonded to each other at one or a plurality of bonding sites, and are bonded by a single coupling agent portion at one of the bonding sites.

Increasing of the thermal conductivity of heat dissipation members has conventionally been carried out by adding a large amount of an inorganic filler material to a matrix of general-purpose resins such as silicone resin, polyamide resin, polystyrene resin, acrylic resin, or epoxy resin, since the contact portions between particles of the filler increase when the filling rate of the filler increases. However, since the filler is solid, the contact form thereof is point contact in most cases, and since the contact is solid-to-solid, the thermal resistance of the contact interface is also high, whereby thermal conductivity cannot be sufficiently enhanced.

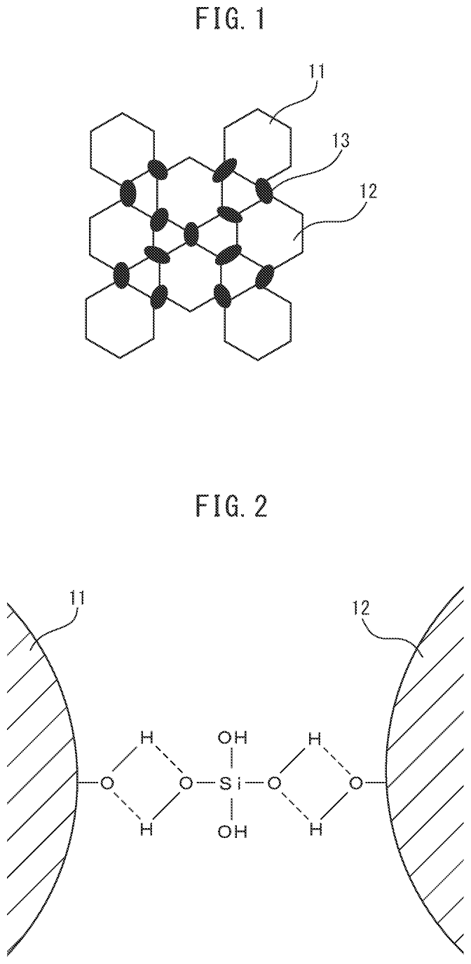

In connection thereto, as shown in FIG. 1, the thermally-conductive material of the present invention comprises a first inorganic filler 11, a second inorganic filler 12, and a coupling agent portion 13. The first inorganic filler 11 and the second inorganic filler 12 are bonded to each other at one or a plurality of bonding sites, and are bonded by a single coupling agent portion 13 at one of the bonding sites. Thus, since the fillers are not in physical contact in the thermally-conductive material of the present invention but are closely bonded by a single coupling agent portion, phonons, which are the main element of heat conduction, can directly propagate therethrough, whereby thermal conductivity between the fillers can be improved.

The first inorganic filler and the second inorganic filler may be bonded at only a single bonding site, as shown in FIG. 1, or may be bonded at two or more sites. Only a single coupling agent portion is present in a single bonding site.

<Coupling Agent>

A compound which is capable of reacting with an OH group as a functional group imparted to the inorganic filler is used as the coupling agent. It is preferable that a silane compound having at least two alkoxy groups (—OR groups, where R is an alkyl group) on an end thereof be used as such a compound. Specifically, conventionally used compounds can be used as a silane coupling agent. Silane compounds such as tetraethoxysilane, methyltriethoxysilane, dimethyldiethoxysilane, methyltrimethoxysilane, and dimethyldimethoxysilane can be used as this silane coupling agent.

“Coupling agent portion” means the remaining portion excluding the group removed from the coupling agent by the reaction of the coupling agent with the OH group (functional group) of the inorganic filler. Thus, when tetraethoxysilane is used as the coupling agent, the “coupling agent portion” means —Si(C₂H₅O)₂— or —Si(OH)₂— in which the ethoxy group has become a hydroxy group by hydrolysis.

<Inorganic Fillers>

The type, form, size, addition amount, etc., of the inorganic fillers can be appropriately selected in accordance with purpose. Furthermore, the first inorganic filler and the second inorganic filler may be the same or may be different. At least one selected from the group consisting of boron nitride, boron carbide, boron nitride carbon, graphite, carbon fiber, and carbon nanotubes can be used as the inorganic filler. It is preferable that hexagonal boron nitride be used. Boron nitride has very high thermal conductivity in the planar direction, and a low dielectric constant, and is highly insulative.

In order to achieve a high thermal conductivity and packing rate, the average particle diameter of the inorganic filler may be 0.1 μm or more, or 1 μm or more, and may be 200 μm or less, or 100 μm or less.

Though the ratio of the inorganic filler to the coupling agent portion depends on the amount of inorganic filler used and the amount of coupling agent to be bonded, it is preferable to allow the inorganic filler to bond with the coupling agent to the greatest extent possible.

«Thermally-Conductive Material Production Method»

The method for the production of a thermally-conductive material of the present invention includes the steps of:

supplying an inorganic filler having a hydroxy group, and

mixing the inorganic filler with a coupling agent having at least two groups capable of coupling with a hydroxy group to bond the inorganic filler and the coupling agent by dehydration condensation.

<Inorganic Filler Having Hydroxy Group Supply Step>

In the method of the present invention, first, an inorganic filler having a hydroxy group is supplied. The inorganic filler having the hydroxy group is the above inorganic filler provided with a functional hydroxy group. Because there are no or few functional groups from which the bond with the coupling agent can originate, it may not be easy for the coupling agent to bond to the surface of the inorganic filler. Bonding with a coupling agent is facilitated by providing the inorganic filler with a hydroxy group as a functional group. The provision of a hydroxy group to the inorganic filler can be carried out by a conventional method. For example, bonding can be carried out by heating at 950 to 1000° C. for 8 to 24 hours in air.

<Inorganic Filler and Coupling Agent Bonding Step>

Next, the inorganic filler having a hydroxy group and the coupling agent are bonded. In this step, using the case in which tetraethoxysilane is used as the coupling agent as an example, first, the tetraethoxysilane undergoes hydrolysis, whereby the ethoxy group becomes a hydroxy group, as shown in the formula below. The hydrolysis can be carried out by a conventional method, for example, by agitating in an acidic solution.

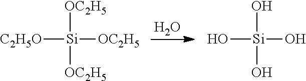

Next, the inorganic filler and the hydrolyzed tetraethoxysilane are mixed to form a hydrogen bond between the OH group of the inorganic filler and the OH group of the hydrolyzed tetraethoxysilane, as shown in FIG. 2.

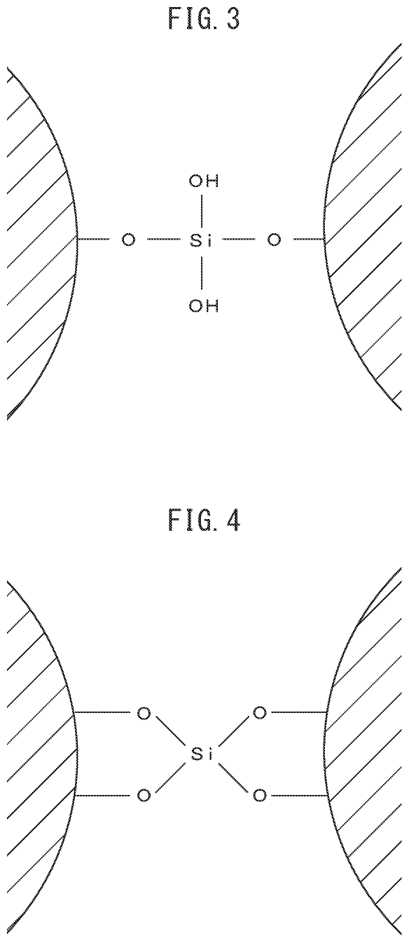

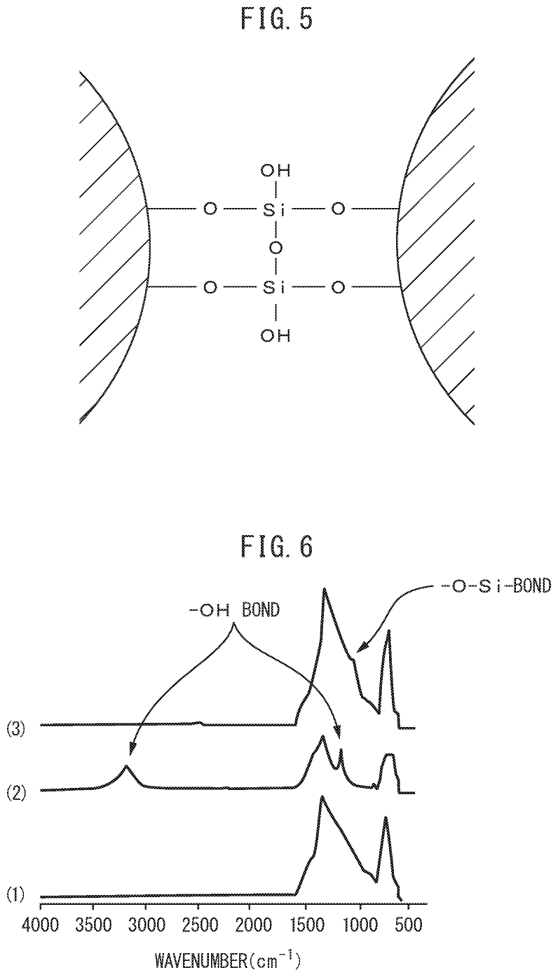

Thereafter, the inorganic filler and a portion of the tetraethoxysilane are bonded by dehydration condensation, as shown in FIG. 3. The bond between the organic filler and the portion of the tetraethoxysilane can be any of the various forms shown in FIGS. 4 and 5. The dehydration condensation can be carried out by a conventional method.

«Thermally-Conductive Composition»

The thermally-conductive composition of the present invention include, in addition to the thermally-conductive material described above, various types of components which are generally used as thermally-conductive compositions. Examples of such components include polymer compounds such as polyolefin resins and polyvinyl resins, polymerizable compounds such as vinyl derivatives and styrene derivatives, additives for adjusting viscosity and color of the composition, and stabilizers.

### EXAMPLES

### Example 1

(Step 1: Imparting Hydroxy Group to Boron Nitride Particle Surface)

5 g of boron nitride particles (PT110) produced by Momentive Corp., were added to an alumina crucible. The crucible was placed into a muffle furnace and heat-treated at 950° C. for 8 hours in atmosphere. Thereafter, the crucible was slow cooled to room temperature and removed.

(Step 2: Hydrolysis of Silane Coupling Agent)

Acetic acid was added dropwise into distilled water to adjust the pH to 3. 0.6 g of silane coupling agent (KBE-04, tetraethoxysilane) manufactured by Shin-Etsu Chemical Co., Ltd., was added dropwise to this solution and agitated until dissolved, whereby the ethoxy group in the tetraethoxysilane was hydrolyzed to obtain a hydroxy group.

(Step 3: Hydrogen Bonding of Silane Coupling Agent to OH Group on Boron Nitride Particle Surface)

The boron nitride having a hydroxy group imparted thereto obtained in step 1 was added to the solution including the hydrolyzed tetraethoxysilane obtained in step 2, and the solution was agitated at room temperature. Next, the solution was heated at 80° C. while stirring to dry the solution. The obtained particles were pulverized in a mortar, placed in a centrifuge with ethanol, and washed using the centrifuge to hydrogen bond the OH group on the boron nitride particle surface with the OH group on the silane coupling agent.

(Step 4: Dehydration Condensation of Silane Coupling Agent from Boron Nitride Particles)

The particles which were washed as described above were placed in a φ10 mm powder compacting die, and were molded so that the thickness after molding was about 0.5 mm and the compact density was 2000 kg/m³. Thereafter, the compact was removed from the die, placed in a drying furnace, and heated at 120° C. for 6 hours, whereby the OH groups on the boron nitride particle surface and the OH groups on the silane coupling agent underwent dehydration condensation and the boron nitride particles bonded with the silane coupling agent.

The FT-IR spectrums of the untreated boron nitride particles, the OH group-added boron nitride particles, and the boron nitride particles to which a tetraethoxysilane moiety bonded were measured. The spectrums are shown in FIG. 6. In FIG. 6, (1) is the spectrum of the untreated boron nitride particles, (2) is the spectrum of the OH group-added boron nitride particles, and (3) is the spectrum of the boron nitride particles to which a tetraethoxysilane moiety bonded. Peaks derived from an —OH group and an —O—Si bond were confirmed.

### Comparative Example 1

A compact was obtained in the same manner as in Example 1 except that the step of heating at 120° C. for six hours in step 4 was not performed. In other words, in the obtained compact, the inorganic filler and the coupling agent were bonded by a hydrogen bond, and were not chemically bonded.

### Comparative Example 2

A compact was obtained in the same manner as Example 1 except that steps 2 and 3 were not performed and the step of heating at 120° C. for six hours in step 4 was not performed. In other words, in the obtained compact, only a hydroxy group was imparted to the boron nitride. Bonding via a coupling agent was not performed.

### Comparative Example 3

5 g of boron nitride particles (PT110) manufactured by Momentive Corp., and 0.75 g of 3-aminopropyltrimethoxysilane were added to 50 mL of toluene (anhydrous), and were then stirred for one hour at 750 rpm using a stirrer. The obtained mixture was heated at 40° C. for 5 hours, and thereafter dried at room temperature for 19 hours. After solvent drying, heat treatment was performed for 5 hours in a vacuum using a vacuum dryer set at 125° C.

The boron nitride particles to which the coupling agent had bonded were transferred to a sample tube, 50 mL of tetrahydrofuran (manufactured by Nacalai Tesque, Inc.) was added thereto, and thereafter, were pulverized by sonication. This solution was separated and purified at 6000 rpm for 10 minutes using a centrifuge. After discarding the supernatant, 50 mL of acetone was added thereto and the same operation was performed twice. The purified boron nitride particles were dried in an oven at 60° C. for 24 hours. The obtained particles were designated as the first inorganic filler A.

2 g of the first inorganic filler A and 4 g of a liquid crystalline epoxy represented by the following formula:

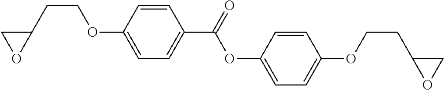 [SMILES: O=C(Oc1ccc(OCCC2CO2)cc1)c1ccc(OCCC2CO2)cc1]

were weighed on a powder medicament paper (boron nitride blending ratio: 19% by volume), were mixed using a mortar, and thereafter were kneaded at 120° C. for 10 minutes using a biaxial roller. Thereafter, the mixture was separated and purified by sonication and centrifugation to remove unreacted components, whereby coupling agent-bonded boron nitride particles were obtained. These particles were designated as the second organic filler B.

0.5972 g of the first inorganic filler A and 1.4812 g of the second inorganic filler B were weighed, were then mixed in an agate mortar, and were thereafter mixed at 55° C. for 10 minutes using a biaxial roller. The obtained mixture was placed in a φ10 mm powder compacting die, was molded so that the thickness after molding was about 0.5 mm and the compact density was 2000 kg/m³, heated to 150° C., and the heating state was maintained for 15 minutes. Thereafter, the compact was removed from the die, placed in an oven, and post-curing was carried out at 80° C. for 1 hour and at 150° C. for 3 hours. In the obtained compact, the boron nitride was bonded via coupling agent-epoxy-coupling agent.

<Measurement of Thermal Conductivity>

The compacts obtained in Example 1 and Comparative Examples 1 to 3 were blackened with a blackening spray. Next, the thermal diffusivities of the compacts in the parallel direction were measured using a thermal diffusivity measurement device. The thermal conductivities of the compacts were calculated using the following formula:

(Thermal Diffusivity)×(Compact Density)×(Compact Ratio)

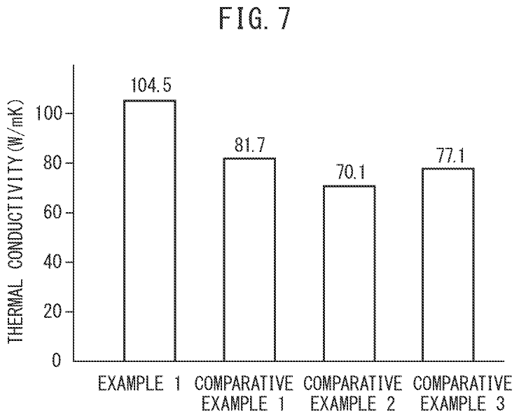

The results are shown in FIG. 7.

As is clear from the results shown in FIG. 7, the thermally-conductive material of the present invention demonstrated improved thermal conductivity.

What is claimed is:

1. A thermally-conductive material, comprising a first inorganic filler, a second inorganic filler, and a coupling agent portion, wherein the first inorganic filler and the second inorganic filler are bonded to each other at one or a plurality of bonding sites, and are bonded by a single coupling agent portion at one of the bonding sites.

2. The thermally-conductive material according to claim 1, wherein the coupling agent portion is a portion derived from a silane compound having at least two alkoxy groups.

3. The thermally-conductive material according to claim 2, wherein the silane compound having at least two alkoxy groups is tetraethoxysilane.

4. The thermally-conductive material according to claim 1, wherein the first inorganic filler and the second inorganic filler are each independently selected from the group consisting of boron nitride, boron carbide, boron nitride carbon, graphite, carbon fiber, and carbon nanotubes.

5. A method for the production of a thermally-conductive material, comprising the steps of:
supplying an inorganic filler having a hydroxy group, and
mixing the inorganic filler with a coupling agent having at least two groups capable of coupling with a hydroxy group to bond the inorganic filler and the coupling agent by dehydration condensation.

6. The method for the production of a thermally-conductive material according to claim 5, wherein the coupling agent is a silane compound having at least two alkoxy groups.

7. The method for the production of a thermally-conductive material according to claim 6, wherein the silane compound having at least two alkoxy groups is tetraethoxysilane.

8. The method for the production of a thermally-conductive material according to claim 5, wherein the first inorganic filler and the second inorganic filler are each independently selected from the group consisting of boron nitride, boron carbide, boron nitride carbon, graphite, carbon fiber, and carbon nanotubes.

9. A thermally-conductive composition comprising the thermally-conductive material according to claim 1.

10. A thermally-conductive composition comprising the thermally-conductive material according to claim 2.

11. A thermally-conductive composition comprising the thermally-conductive material according to claim 3.

12. A thermally-conductive composition comprising the thermally-conductive material according to claim 4.
